(19) United States
(12) Patent Application Publication
(10) Pub. No.: US 2004/0178674 A1
(43) Pub. Date: Sep. 16, 2004

(54) Device and method for detecting brake pressure

(76) Inventors: Peter Lohberg, Bad Soden (DE); Michael Zydek, Friedrichsdorf (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/483,351

(22) PCT Filed: May 28, 2002
(86) PCT No.: PCT/EP02/05838

(30) Foreign Application Priority Data
Jul. 12, 2001 (DE) 101 33 293.9
Feb. 7, 2002 (DE) 102 05 012.0

(51) Int. Cl. B60T 8/36

(52) U.S. Cl. 303/119.3

(57) ABSTRACT

The invention discloses an electrohydraulic pressure control device (30) with integrated pressure sensors (16) for sensing the pressure of a fluid in pressure lines (34), wherein several pressure transducers (16) are arranged in a hollow space (10), each comprising a pressure metering diaphragm (32) and an electrically passive transducer (33), and the transducer does not comprise a device for calibration of the electric transducer signal.

The invention further discloses a method for the compensation of errors, wherein error-corrected pressure parameters are calculated from the pressure parameters of the pressure sensors by means of a numerical allocation specification.

The present invention relates to an electrohydraulic pressure control device according to the preamble of claim 1, in particular in electrohydraulic control devices for electronically controlled brakes (ABS, TCS, ESP, etc.) for motor vehicles, and a method for the compensation of errors according to the preamble of claim 7.

Electronically controlling brake devices are known in the art (Brake Handbook, ‘Electronic Brake Systems’, 1955, ISBN 3-89059-026-8). They comprise a hydraulic control unit, also referred to as valve block, and an electronic controller (EC) in an assembly. The hydraulic control unit comprises a motor-and-pump assembly and a valve block flanged thereto. The motor-and-pump assembly provides the pressurized fluid volume required in the pressure build-up phase during brake control. The inlet and outlet valves grouped in the hydraulic control unit permit the modulation of the wheel brake pressures. The brake lines to the wheel brakes are connected to the valve block. The hydraulic valves in the valve block are operated by way of electromagnetic coils that are arranged within the electronic controller housing. The signals of four wheel speed sensors are among others sent to the electronic controller for detecting driving conditions.

Further, control devices with integrated pressure sensors are disclosed in the not published former German patent application P 10122330.7, wherein pressure sensors are provided to measure the pressure in the hydraulic lines for improving hydraulic pressure control.

International publications WO 98/41831, WO 00/17025 and WO 99/30943 disclose grouping several pressure sensors in one joint holding device and screwing said holding device with the hydraulic control unit, the said sensors being additionally connected hydraulically to the hydraulic control unit. Active electronic circuits for signal conditioning are integrated into the pressure sensor housing of pressure sensors customary on the market. It is, however, also disclosed arranging the circuits for signal conditioning on the holding devices and providing a plug arrangement for signal connection to the electronic controller.

The invention arranges for improving a prior-art electrohydraulic pressure control device according to claim 1.

According to the invention, pressure transducers are preferably designed in such a manner for the sensoric sampling of a hydraulic channel that a passive, uncompensated strain bridge is fitted to the transducer's pressure metering diaphragm and is connected in particular to a corresponding number of contact surfaces for establishing an electric connection to the electronic controller by way of cooperating contacts. The connection by way of cooperating contacts is established according to the invention preferably by omitting the integration of an active electronic circuit for signal pre-amplification, signal conditioning and error compensation of the strain bridge, which is conventional in the state of the art.

The present invention also relates to braking devices, which evaluate the pressure data of one or more hydraulic connections in the valve block in addition.

In another preferred embodiment of the device, the invention discloses realizing the electronic signal conditioning for all individual pressure transducers of the pressure channels existing in the hydraulic control unit in terms of circuitry as a part of an integrated circuit in the electronic controller. It is especially suitable to arrange for exactly one integrated circuit. However, simplification is achieved already when the number of the integrated circuits is chosen to be smaller than the number of the existing pressure transducers.

In another preferred embodiment, the electronic controller comprises calculating means, in particular realized by one or more microcomputers or microcontrollers, allowing the elimination of errors in the measuring chain of each individual pressure channel by electronically evaluating two functionally separate calculations of correction values or correction tables at least to a greater extent.

Preferably, the housing bodies of the pressure transducers are attached to the hydraulic control unit either by way of a fixing structure (e.g. a perforated plate), by using appropriate fixing elements (e.g. one or more screws) or also preferably in such a manner that the housing bodies of the pressure transducers are fastened directly to the hydraulic control unit, in particular by way of a clinched engagement.

The invention further relates to a method for the compensation of errors according to claim 7.

A pressure transducer maps the pressure (differential pressure) determined at a metering diaphragm on an electric signal (e.g. ohmic resistance of the strain bridge). An individual sensor is initially gauged or calibrated for interpretation of the electric signal. The pairs of values allocating the electric parameter to the physical pressure quantity are generally dependent on further ambient parameters, especially the ambient temperature. It is appropriate to initially define a suitable allocation between pressure quantity and electric quantity and designate existing differences between the electric signal values and the expected signal value as deviation.

According to the method of the invention, the deviations of an individual pressure transducer are determined as a function of pressure and temperature, and/or the deviations of the signal-conditioning stage associated with the individual pressure transducer, in particular including the associated analog/digital converter, are determined as a function of the signal input voltage and/or the temperature by way of value measurements and stored in the electronic controller, individually allocated in data memories.

Preferably, at least two operations of detecting correction values, separated in terms of space and/or time, are performed to this end: In a first correction value detection operation, correction values for the individual pressure transducers (mainly the ‘mechanical’ components of the pressure sensor(s)) are determined. Further, correction values for the corresponding signal-conditioning channel(s) (mainly ‘electronic’ components of the pressure sensor channel((s)) are additionally determined in another correction value detection operation. A spatial separation of the above correction value detection is suitable especially when the fabrication of the mechanical and electronic components of the device of the invention takes place at different locations.

Preferably, a measuring value found at the pressure sensor is converted at a later point of time (after determination of the correction values, i.e. during pressure measurement) into a corrected pressure measuring value by using two linked correction values. This conversion is suitably done individually for each hydraulic channel, e.g. by using two or more correction value matrices.

In a particularly favorable manner, the device and the method of the invention may be implemented in electrohydraulic brake systems (EHB).

The solution of the invention offers the advantage of considerable simplification and cost reduction among others in arrangements with several pressure transducers. The cause for this is essentially the simplification in the electronic evaluating circuit of the pressure sensors that implies managing with a smaller number of electronic components. Another advantage involves that it is possible to use mechanical/hydraulic constructions well tested already in large-scale production. For the maker of corresponding motor vehicle components, this favorably reduces the calibration effort to a measurement of the error curve before and particularly after the installation of the component into the motor vehicle. The motor vehicle manufacturer can suitably group the integrated circuit and the pressure transducer on the assembly line to obtain a structural unit. It is also possible to carry out a calibration after completion of a control device made up of hydraulic unit and electronic controller at the premises of the manufacturer of the brake system. A major advantage is that there is no need for a calibration at the premises of the manufacturer of the pressure sensors.

Further preferred embodiments can be taken from the sub claims and the following description of the Figures.

In the drawings,

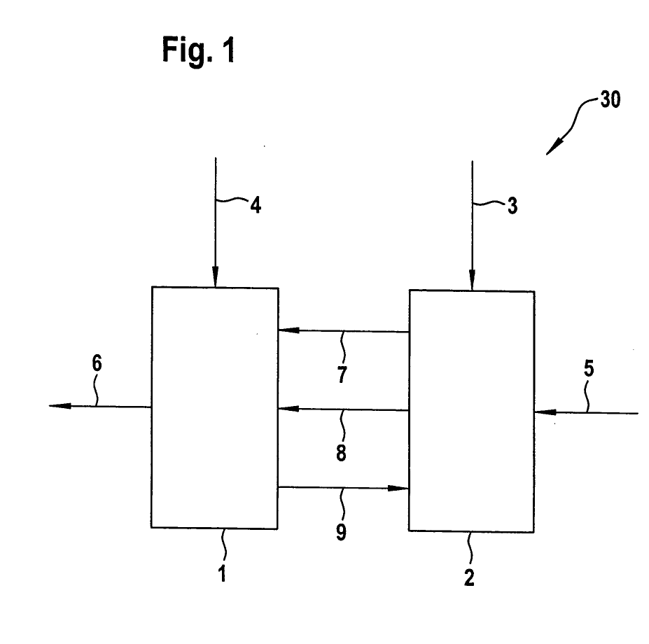

FIG. 1 is a schematic view of the function elements of an electrohydraulic control device of the prior art.

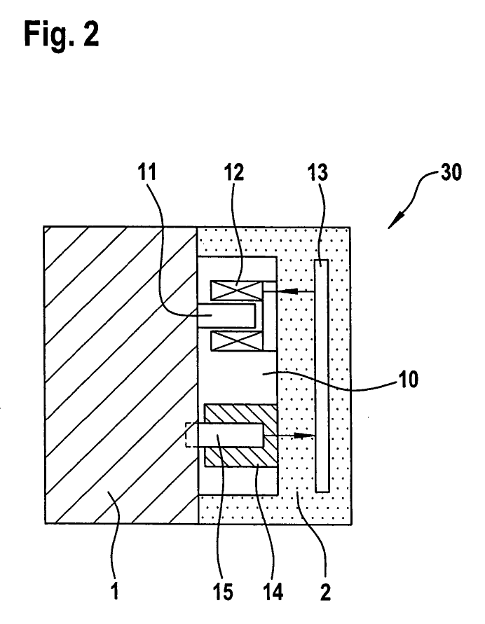

FIG. 2 is a simplified cross-sectional view of a monolithic brake control device according to prior art.

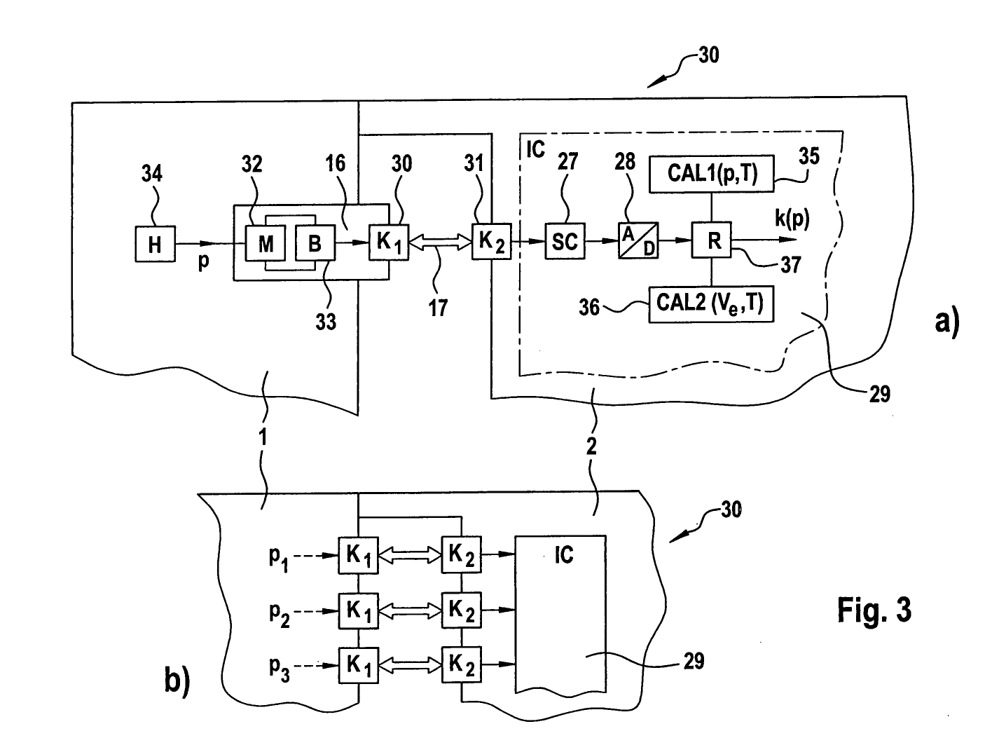

FIG. 3 is a schematic view of a device of the invention for pressure measurement in a control device.

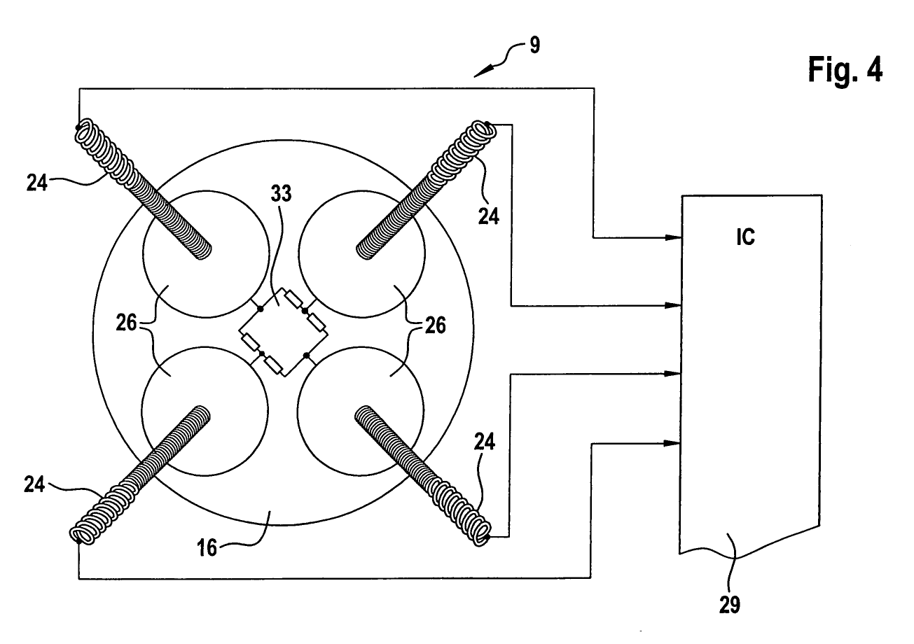

FIG. 4 is a schematic, partly perspective view of a pressure sensor interface according to the invention.

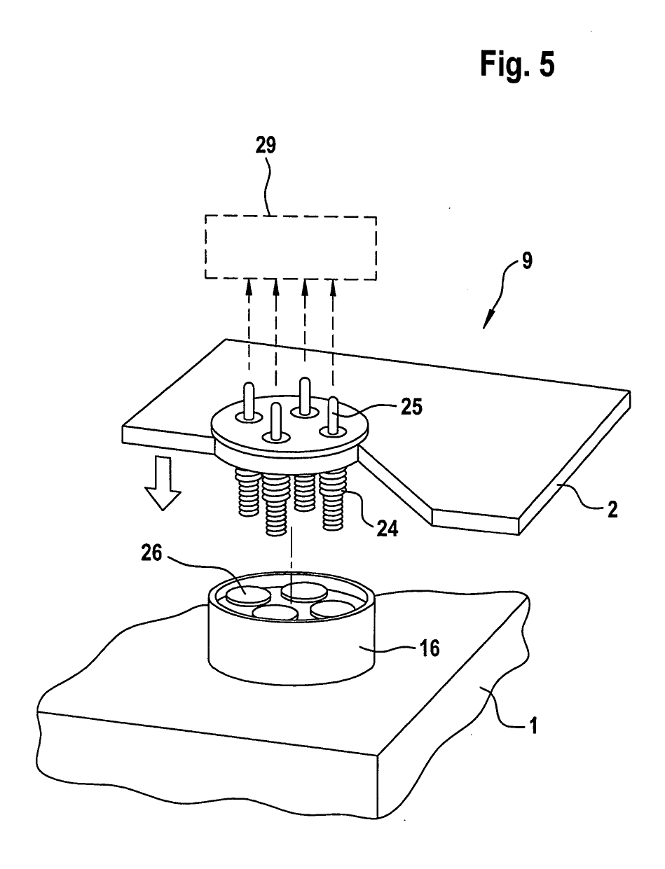

FIG. 5 is another perspective view of the pressure sensor interface of the invention.

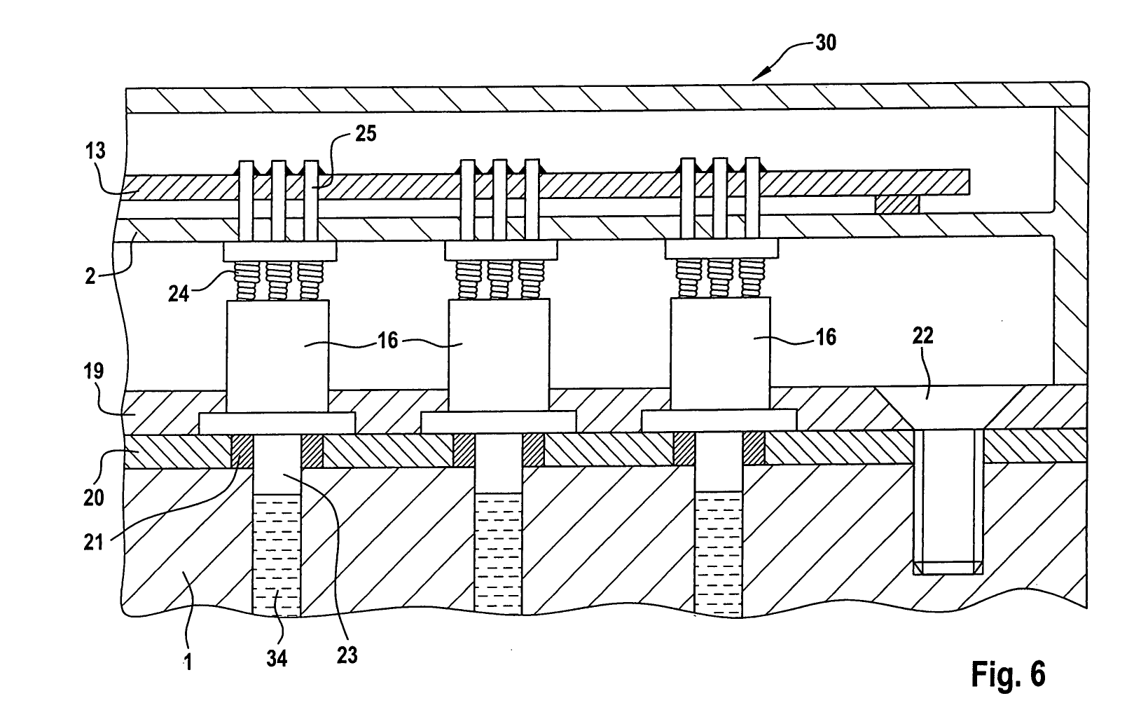

FIG. 6 is a cross-sectional view of a sub-range of a control device with an arrangement composed of several pressure sensors.

FIG. 1 shows in a schematic view the basic function blocks of a per se known electrohydraulic pressure control device 30 (control device) for the actuation of hydraulically operated motor vehicle brakes. Pressure control device 30 comprises a valve block 1 and an electronic controller 2. Valve block and electronic controller form a structural unit. Valve block and electronic controller are interconnected by way of an electric and magnetic interface 7, 8, 9. Electric energy 3 is supplied to the electronic controller, hydraulic energy 4 is supplied to the valve block. Further sensor signals 5 from external sensors, such as wheel speed sensors, yaw rate sensors, switch conditions etc., by which the current driving state can be determined, are sent to the controller 2. Valve block 1 conducts pressure-modulated brake fluid 6 to the brakes in response to the signals of the electronic control. The compound interfaces 7, 8, 9 are obtained by the monolithic design of the device 30 and the construction principle of the per se known magnetic plug with two independent and separable units. In this arrangement, reference numeral 7 designates an electric plug coupling for the energy supply of the pump motor, and reference numeral 9 designates a sensor interface for the transmission of pressure signals. Reference numeral 8 refers to a so-called ‘magnetic plug’ enabling actuation of the hydraulic valves in the valve block in a magnetic fashion by way of coils.

FIG. 2 displays the construction set-up of the brake system or the brake control device 30. The electronic controller 2 is encompassed by a generally shell-type housing accepting the valve coils 12 for engagement in valve domes 11 on the side close to the valve block. Along with the valve block, the result is hollow space 10 wherein the elements of the interfaces 7, 8, 9 of FIG. 1 are accommodated in a way protected against environmental influences. When valve coil 12 is electrically energized, an armature is moved magnetically in valve dome 11 so that the hydraulic valve arranged in the valve block and connected to the valve dome is actuated. On the other hand, case 14 connected to the controller 2 and pressure sensor 15 connected to valve block 1 form the sensor interface 9. When the electronic controller and the valve block are put together, the valve domes are inserted into corresponding bores of the coils. This additionally achieves an electric connection between the sensor interface 9 and the non-illustrated electric connection 7 for the pump motor. Embedded into the housing of the electronic controller is an electronic circuit carrier 13 to which are sent electrically converted pressure signals and which generates, among others, electric signals for the energization of coils.

By example of a single sensor, the design of the pressure sensor assembly of the invention is demonstrated in FIG. 3a by means of function blocks. Initially, pressure transducer 16 senses the pressure in hydraulic channel 34. Pressure transducer 16 includes a pressure metering diaphragm 32 and a passive and uncompensated strain bridge 33 mounted thereon. Further, the pressure transducer includes a corresponding number of contact surfaces 31 for making an electric connection 17 with the electronic controller by way of cooperating contacts 32. Pressure transducer 16 does not comprise electrically active components (e.g. boosters). The strain bridges B are per se known piezoresistive resistors or-expandable thin-film resistors connected to the diaphragm.

Partial picture b of FIG. 3 shows an example for a pressure sensor assembly of the invention with several pressure sensors, wherein the electronic signal-conditioning stage 27 for all individual pressure transducers of the pressure channels p1, p2, p3 . . . etc. is realized in terms of circuitry as a part of an integrated circuit 29 in the electronic controller, grouping the active components of the individual sensors on one common chip.

As shown in partial picture a, a calibration of the electric signals of sensor 16 is carried out during measurement in the electronic controller 2. Each individual electric pressure signal is converted into a digital signal by way of analog/digital converter 28. A signal-conditioning stage 27 can be provided at the input of A/D-converter 28, comprising a signal-conditioning channel together with the A/D-converter. The electronic calibration is carried out program-controlled in a microprocessor system 37. Microprocessor system 37 executes a method by which the measured values found are corrected by means of two functionally separate, memorized correction value calculations 35, 36 or correction tables. On the one hand, the deviations of the individual pressure transducer are hereby determined as a function of pressure (p) and temperature (T), while, on the other hand, the deviations of the signal-conditioning stage 27 allocated to the individual pressure transducer including the associated analog/digital converter 28 are determined as a function of the signal input voltage Vₑ and the temperature T by way of value measurements, and stored in the electronic controller, allocated individually in data memories 35 CALL (p, T) and 36 CAL2 (Vₑ, T). With each measured value determined by sensor 16, the microprocessor system 37 will then determine a numerical value k(p) as a standard of the pressure in the individual hydraulic channel 34, by offsetting the two correction value portions.

The sensor interface is illustrated in FIGS. 4 and 5. Wheatstone bridge 33, composed of resistive wire strain gauges, is attached on the diaphragm (not shown) of pressure transducer 16. The temperature can be determined either by measuring the temperature-responsive resistance of bridge 33 or by means of an additional temperature sensor. The connections of bridge 33 lead via metal or metallized contact surfaces 26, connected to the housing body of the pressure transducer 26, to integrated circuit 29. Pressure transducer 16 is inserted in valve block 1. Contact springs 24 are attached to controller housing 2. When joining valve block 1 and the housing of the electronic controller 2, an electric connection is constituted by placing contact springs 24 on contact surfaces 26 (interface 9).

FIG. 6 shows an example for the attachment of the housing bodies of the pressure transducers 16 by way of a plate 19 with screws 22 to valve block 1. A sealing plate 20 with inserted seals 21 is arranged between plate 19 and valve block 1. Attached to pressure transducers 16 are ascending pipes 23 to which hydraulic fluid is applied by way of individual hydraulic channels 34. Contact springs 24 are connected to housing 2 of the electronic controller. Extending from springs 24 are electric connections that project into corresponding bores in printed circuit board 13 and are soldered to said, or are conductively connected therewith by per se known press-in contacts.

1. Electrohydraulic pressure control device (30) with integrated pressure sensors (16) for sensing the pressure of a fluid in pressure lines (34), wherein the device is made up of a valve block (1) and an electronic controller (2) joined by way of a magnetic plug to provide a compact sealed structural unit with a hollow space (10),
characterized in that several pressure transducers (16) are arranged in the hollow space (10), each comprising one pressure metering diaphragm (32) and an electrically passive transducer (33), and the transducer does not comprise a device for calibration of the electric transducer signal.

2. Pressure control device as claimed in claim 1,
characterized in that an integrated, electronically error-uncompensated active circuit (29) is arranged in the electronic controller, conditioning the individual signals of all pressure transducers under signal technology aspects and subsequently conducting them to an electronic arithmetic unit (37).

3. Pressure control device as claimed in at least any one of the preceding claims,
characterized in that the housing bodies of the pressure transducers are connected to the valve block by clinched engagement.

4. Pressure control device as claimed in at least any one of the preceding claims,
characterized in that the housing bodies of the pressure transducers (16) are connected to the valve block (1) by way of a fixing structure (19).

5. Pressure control device as claimed in at least any one of the preceding claims,
characterized in that when joining valve block (1) and electronic controller (2), a galvanic connection is established with the electric supply lines of the transducer by means of contact spring (24).

6. Pressure control device as claimed in claim 5,
characterized in that the electric supply lines of the transducer (16) are in electrical, detachable contact with metal or metallized contact surfaces (26) that are insulated from the housing body of the transducer and connected to it.

7. Method for the compensation of errors, which is implemented electronically especially in a pressure control device as claimed in at least any one of claims 1 to 6,
characterized in that error-corrected pressure parameters are calculated from the pressure parameters of the pressure sensors by means of a numerical allocation specification, and the calculation takes into consideration deviations caused on account of temperature variations and influences of the signal-conditioning channel (27, 28).

8. Method as claimed in claim 7,
characterized in that at least two correction value detection operations (35, 36), separated in terms of space and/or time, are performed, and correction values for an individual pressure transducer (16) are determined during a first correction value detection operation (35), and correction values for one or more signal-conditioning channel(s) (27, 28) are determined in another correction value detection operation (36).

9. Method as claimed in claim 8,
characterized in that the separately determined correction values are linked to each other in an electronic arithmetic unit (37).

10. Method as claimed in claim 8 or 9,
characterized in that the correction values obtained in a correction value detection operation are respectively stored in an independent data range or data medium.

11. Method as claimed in at least any one of claims 8 to 10,
characterized in that correction values relating to the deviations of the output value as a function of the brake pressure and the prevailing temperature are stored in a first error matrix (35), and the correction values relating to the deviations of the output value as a function of the signal input voltage and the prevailing temperature are stored in another error matrix (36).
